(19) United States
(12) Patent Application Publication
(10) Pub. No.: US 2024/0093321 A1
(43) Pub. Date: Mar. 21, 2024

(54) METHODS AND SYSTEMS FOR VACUUM AND OIL AUSTEMPERING IN PRODUCING BAINITE

(71) Applicant: Cummins Inc., Columbus, IN (US)

(72) Inventor: Andrew M. Armuth, Columbus, IN (US)

(21) Appl. No.: 18/364,703

(22) Filed: Aug. 3, 2023

Related U.S. Application Data
(63) Continuation of application No. PCT/US2022/014897, filed on Feb. 2, 2022.
(60) Provisional application No. 63/146,324, filed on Feb. 5, 2021.

(51) Int. Cl. C21D 1/20; C21D 1/58; C21D 1/74; C21D 6/00; C21D 9/00

(52) U.S. Cl. CPC C21D 1/20; C21D 1/58; C21D 1/74; C21D 6/00; C21D 9/0062; C21D 2211/002

(57) ABSTRACT

Methods and apparatuses for obtaining bainite are disclosed. The method includes heating a metal component in a vacuum chamber of a vacuum furnace to raise an internal temperature of the metal component, transferring the metal component from the vacuum chamber to a quench chamber of the vacuum furnace, quenching the metal component in oil that is maintained at a bainite-forming temperature range within a quench reservoir of the quench chamber, and removing the metal component from the quench chamber after a predetermined period of time.

### CROSS-REFERENCE TO RELATED APPLICATION

This application claims priority to U.S. Provisional Application No. 63/146,324, filed on Feb. 5, 2021, incorporated herein by reference in its entirety.

### FIELD OF THE DISCLOSURE

The present disclosure relates generally to heat treatment processes for carbon alloy steels and more specifically to heat treatment processes involving austempering the carbon alloy steels to produce bainite.

### BACKGROUND OF THE DISCLOSURE

Austempering is an arrested quench process designed to produce a bainitic microstructure having properties that combine high hardness with toughness, resulting in a resistance to brittle fatigue. Austempering involves an isothermal transformation at a temperature below that of pearlite formation and above that of martensite formation. This process produces materials with higher ductility at high hardness, increased strength and ductility at a given hardness, increased toughness, greater fatigue life, and less distortion and cracking. The known methods for austempering utilizes dry austempering with gas quench and wet austempering with salt bath to produce bainite. However, the use of salt bath has a negative effect on the functional properties of the component due to surface anomalies in the microstructure caused by the chemical reactions that occur with salt, as well as the byproducts of the salt bath austempering being harmful to the environment. Dry austempering has limitations in cooling that negatively affect components with different cross-sectional thickness as well as limitations to total cross-sectional thickness. Accordingly, further contributions are needed in this area of technology.

### SUMMARY OF THE DISCLOSURE

According to the present disclosure, methods and apparatuses for obtaining bainite are disclosed. The method includes heating a metal component in a vacuum chamber of a vacuum furnace to raise an internal temperature of the metal component to an austenitizing temperature, transferring the metal component from the vacuum chamber to a quench chamber of the vacuum furnace, quenching the metal component in oil that is maintained at a bainite-forming temperature range within a quench reservoir of the quench chamber, and removing the metal component from the quench chamber after a predetermined period of time.

In some examples, the bainite-forming temperature range has a lower threshold of at least about 200° C. In some examples, the bainite-forming temperature range has an upper threshold at or less than about 230° C. In some examples, the metal component is a steel alloy containing at least 0.4% carbon and the austenitizing temperature of the metal component is between 815° C. and 880° C. In some examples, the method further includes introducing carbon into the vacuum chamber during heating of the metal component to produce case-hardened bainite from the metal component when the metal component is a steel alloy containing 0.3% carbon or less. In one aspect of the examples, the austenitizing temperature of the metal component is between 815° C. and 950° C. In some examples, the period of time is between 20 seconds and 4 hours.

In some examples, the method includes maintaining the quench chamber at an environment at a vacuum for a period of time before, during, and after transferring the metal component from the vacuum chamber to the quench chamber. In some examples, the method includes maintaining an inflow of inert gas into the quench chamber for a period of time before, during, and after transferring the metal component from the vacuum chamber to the quench chamber. In some examples, the method further includes maintaining an inflow of inert gas into the quench chamber for a period of time before, during, and after the furnace is opened to remove the metal component from the quench chamber. In one aspect of the examples, the inert gas is configured to entirely cover a surface of the oil within the quench reservoir to reduce oxidation or degradation of the oil.

In some examples, the method further includes washing the metal component after removing the metal component from the quench chamber. In some examples, the oil has a flash point of greater than 230° C.

The apparatus used to obtain bainite is a vacuum furnace. The vacuum furnace includes a vacuum chamber configured to heat a metal component to raise an internal temperature of the metal component at or less than an austenitizing temperature, and a quench chamber including a quench reservoir configured to store oil that is maintained at a bainite-forming temperature range to be used to quench the metal component after the metal component is transferred from the vacuum chamber to the quench chamber until bainitic transformation of the metal component is complete.

In some examples, the bainite-forming temperature range has a lower threshold of at least about 200° C. In some examples, the bainite-forming temperature range has an upper threshold at or less than about 230° C. In some examples, the metal component is a steel alloy containing at least 0.4% carbon and the austenitizing temperature of the metal component is between 815° C. and 880° C. In some examples, the metal component is a steel alloy containing 0.3% carbon or less and the vacuum chamber further including a carbon-bearing material during heating of the metal component to produce case-hardened bainite from the metal component. In one aspect of the examples, the austenitizing temperature of the metal component is between 815° C. and 950° C.

In some examples, the vacuum furnace includes an elevator configured to transport the metal component from the quench chamber to the quench reservoir. In some examples, the environment within the quench chamber is maintained at a vacuum for a period of time before, during, and after transferring the metal component from the vacuum chamber to the quench chamber.

In some examples, the quench chamber further includes a gas injector. The gas injector is configured to maintaining an inflow of inert gas into the quench chamber for a period of time before, during, and after the metal component is transferred from the vacuum chamber to the quench chamber, and/or for a period of time before, during, and after the furnace is opened to remove the metal component from the quench chamber. In one aspect of the examples, the inert gas is configured to entirely cover a surface of the oil within the quench reservoir to reduce oxidation or degradation of the oil. In some examples, the oil has a flash point of greater than 230° C.

Also disclosed is a bainite component formed by an austempering process as disclosed herein. The austempering process includes heating a metal component in a vacuum chamber of a vacuum furnace to raise an internal temperature of the metal component to an austenitizing temperature, transferring the metal component from the vacuum chamber to a quench chamber of the vacuum furnace, quenching the metal component in oil that is maintained at a bainite-forming temperature range within a quench reservoir of the quench chamber, and removing the bainite component from the quench chamber after a predetermined period of time. The bainite component has a hardness of between 50HRC and 60HRC with no visible retained austenite, and a surface of the bainite component has no defect formed as a result of oxidation that is visible to a naked eye. In some examples, the surface of the bainite component has no defect formed as the result of oxidation that is visible under 10× magnification.

In some examples, the bainite-forming temperature range has a lower threshold of at least about 200° C. In some examples, the bainite-forming temperature range has an upper threshold at or less than about 230° C. In some examples, the metal component is a steel alloy containing at least 0.4% carbon and the austenitizing temperature of the metal component is between 815° C. and 880° C. In some examples, the process includes introducing carbon into the vacuum chamber during heating of the metal component to produce a case-hardened bainite component, wherein the metal component is a steel alloy containing 0.3% carbon or less. The austenitizing temperature of the metal component may be between 815° C. and 950° C.

In some examples, the process includes maintaining an inflow of inert gas into the quench chamber for a period of time before, during, and after the furnace is opened to remove the metal component from the quench chamber. In some examples, the inert gas is configured to entirely cover a surface of the oil within the quench reservoir to reduce oxidation or degradation of the oil. In some examples, the oil has a flash point of greater than 230° C.

Additional features and advantages of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The detailed description of drawings particularly refers to the accompanying figures in which:

FIG. 1 is a flow diagram of a method of obtaining bainite as known in the art;

FIG. 2 is a flow diagram of a method of obtaining bainite according to embodiments disclosed herein;

FIG. 3 is a flow diagram of a method of obtaining bainite according to embodiments disclosed herein;

FIG. 4 is a flow diagram of a method of obtaining bainite according to embodiments disclosed herein;

FIG. 5 is a flow diagram of a method of obtaining bainite according to embodiments disclosed herein;

FIG. 6 illustrates an example of a vacuum furnace with oil quenching according to embodiments disclosed herein;

FIG. 7 is a graph comparing quench temperature and time of a material according to embodiments disclosed herein with those obtained using methods known in the art;

FIG. 8 is a graph comparing quench oil temperature with core and surface temperatures of the material using methods according to embodiments disclosed herein; and

FIG. 9 is a photograph of a bainitic microstructure observed in a core of a metal component after austempering according to embodiments disclosed herein, as observed under 500× magnification.

### DETAILED DESCRIPTION

The embodiments of the disclosure described herein are not intended to be exhaustive or to limit the disclosure to the precise forms disclosed. Rather, the embodiments selected for description have been chosen to enable one skilled in the art to practice the disclosure.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example.

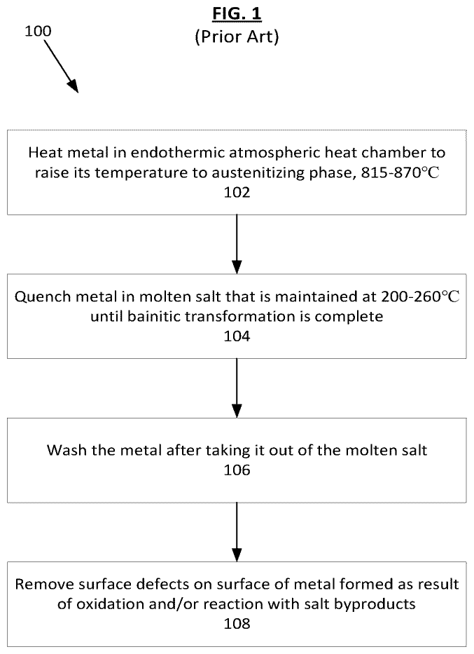

FIG. 1 shows a method of atmosphere-to-salt austempering 100 commonly used to obtain bainite. In such a method 100, a metal component that is to undergo a bainitic transformation is heated in an endothermic atmospheric heat chamber to raise its temperature to austenitizing phase in step 102. The step involves heating the metal component to the temperature range of between 815° C. and 870° C. in the heat chamber in which protective atmospheres (e.g., endothermic) are used in heat treatment to protect the metal component from scaling at the elevated temperatures used during austenitizing. The atmospheres contain inert or protective gases. The protective gases are usually mixtures of carbon monoxide (CO), hydrogen (H₂), nitrogen (N₂), carbon dioxide (CO₂), methane (CH₄) and trace amounts of water vapor. For atmosphere generators, air and hydrocarbon are mixed and introduced with a catalyst such that once at the operating temperature, the gas reacts with air to form the desired atmosphere composition.

The quenching of the metal component is performed in molten salt bath that is maintained at a temperature range from 200° C. to 260° C. in step 104. Heating the component in an endothermic atmosphere results in decarburization and intergranular oxidation (IGO), in which case carbon correction should be made during austenitizing. Austenitizing in a furnace under protective atmosphere (endothermic) allows controlling carbon content in the part using conventional techniques. However, salt quenching system has numerous drawbacks—for example, if general cleanliness guidelines are not followed, soot, metallic debris from parts, or other foreign materials may get into the bath and accumulate over time. Fine contaminants remain in suspension due to bath agitation, and when the contaminants exceed 0.5%, quench severity decreases.

Furthermore, after the metal component is washed to dissolve the salt from the surfaces of the metal component when it is taken out of the molten salt bath in step 106, there is a need for the surface defects or microstructural anomalies to be removed from the surface of the metal component in step 108. The defects are formed on the surface of the metal component as a result of oxidation and other chemical reactions that the metal component undergoes while inside the endothermic atmosphere and salt bath, caused by the presence of oxygen at high temperature. Typically, high-pressure steam, water jet, or water spray is used to wash off any remaining salt as well as machining, blasting, or peening to remove the surface defects before the finished bainite component can be further processed. Furthermore, salt bath quenching causes fatigue reduction in the metal component as well when surface defects are not removed.

Other drawbacks for the salt bath process include the difficulty of storing and disposing the salt that is used. Quenching salt that is used for the molten salt bath is classified as a hazardous material due to its oxidizing nature, and precaution must be taken when handling such materials.

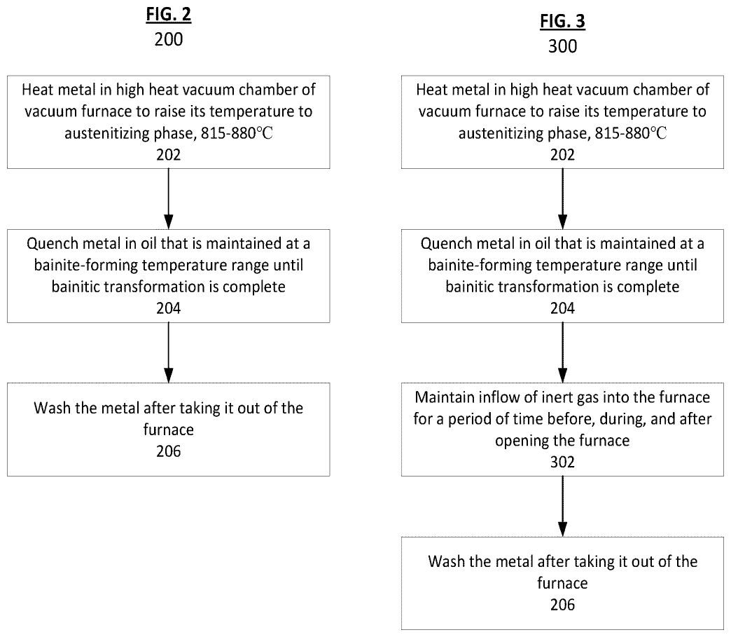

A vacuum furnace that performs a vacuum-and-oil austempering as disclosed herein overcomes the aforementioned disadvantages of endothermic heating and salt bath quenching process. Specifically, an austempering method or process 200 of FIG. 2 for the vacuum-and-oil austempering system to form a bainite component eliminates the need for the molten salt bath to quench the metal component, as well as eliminating the use of an endothermic heat chamber. In step 202, the metal component is heated in a high-heat vacuum chamber of a vacuum furnace, where the atmosphere is removed to facilitate forming a vacuum environment, which has less than 500 microns of atmosphere, for example. The metal component is heated until the internal temperature reaches an austenitizing phase temperature, which is between 815° C. and 880° C. In step 204, the metal component is transferred from the high-heat vacuum chamber to a quench reservoir, where the metal component is quenched in an oil that is maintained at a bainite-forming temperature range until the bainitic transformation of the metal component is complete. Then, the bainite component is washed after it is taken out of the furnace in step 206. The washing can be performed at room temperature.

In an austempering method or process 300 shown in FIG. 3, an additional step 302 of maintaining an inflow of inert gas into the furnace is included between steps 204 and 206. The inflow of inert gas is maintained for a period of time before, during, and after the furnace is opened to remove the metal component (which at this point is a bainite component) from the quench chamber. In some examples, this step may be performed between steps 202 and 204, in which case the inflow of inert gas is maintained for a period of time before, during, and after the metal component is transferred from the high-heat vacuum chamber to the quench chamber. The amount of gas that is injected into the furnace, or more specifically to a quench chamber of the furnace as further explained herein, must be sufficient to entirely cover a surface of the oil within the quench reservoir to reduce oxidation or degradation of the oil. Any portion of the oil that remains uncovered is at risk of oxidation or degradation in the absence of the inert gas protecting the oil.

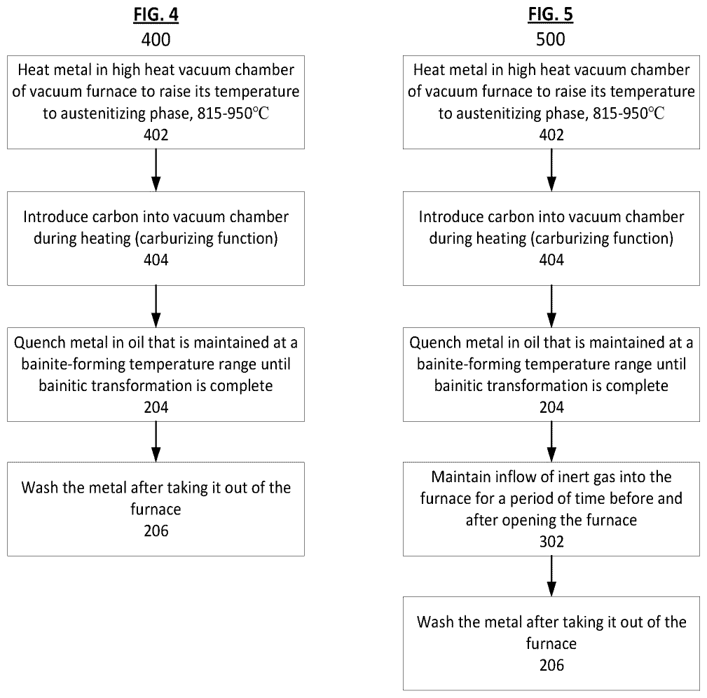

FIG. 4 shows an austempering method or process 400 which includes step 402 of heating the metal component to raise its temperature to austenitizing phase, which is between 815° C. and 950° C. in the high heat vacuum chamber of the vacuum furnace. Then, in step 404, carbon is introduced into the vacuum chamber during heating between steps 202 and 204. The step 404 is known as a carburizing function because the metal component absorbs carbon while being heated in the presence of a carbon-bearing material, for example a carbon-bearing gas or any other suitable material, in order to make the metal component harder. FIG. 5 shows an austempering method or process 500 which further includes the step 302 in addition to step 404. It should be understood that processes 400 and 500 produce a case-hardened bainitic component with a softer core than is produced using processes 200 and 300, which produce a through-hardened bainitic component that has increased hardness throughout.

Austempering processes 400 and 500 are applied for metal components with lower carbon content, for example a weight percentage (wt. %) of 0.3% carbon or less. Hereinafter, constituents are described in weight percentages. In comparison, processes 200 and 300 are applied for the metal components with higher carbon content, for example at least 0.4% carbon. As a nonlimiting illustrative example, the high-carbon metal may be SAE-AISI 52100 chromium steel alloy typically containing 1.4% to 1.6% chromium, 0.93% to 1.1% carbon, 0.25% to 0.45% manganese, 0.15% to 0.35% silicon, and the remaining being iron, with a trace amount of phosphorus and/or sulfur in some cases.

As another nonlimiting illustrative example, the low-carbon metal may be SAE-AISI 8620 nickel-chromium-molybdenum steel alloy typically containing 0.7% to 0.9% manganese, 0.4% to 0.7% nickel, 0.4% to 0.6% chromium, 0.15% to 0.35% silicon, 0.18% to 0.23% carbon, 0.15% to 0.25% molybdenum, and the remaining being iron, with a trance amount of phosphorus and/or sulfur in some cases. Other examples of metal for each case may be implemented as suitable, as known in the art. It is to be understood that the metal component can be in any shape and configuration. The metal component can have cross-sections which vary in size and/or shape along a length of the metal component.

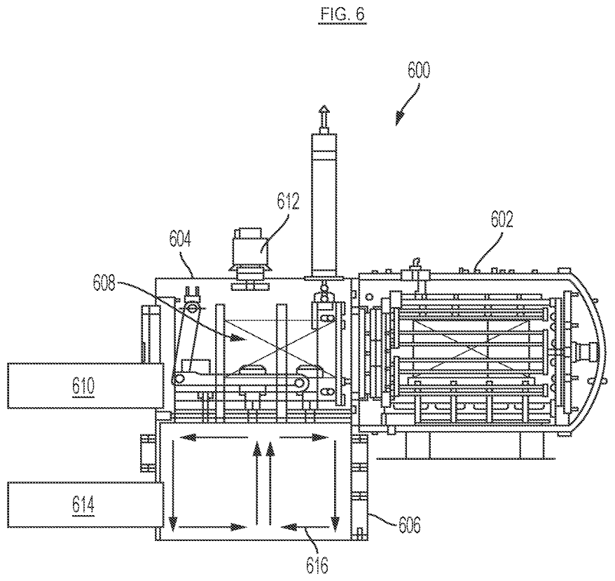

FIG. 6 illustrates an example of a vacuum furnace 600 used in the aforementioned austempering processes 200, 300, 400, and 500. The vacuum furnace 600 is made of two separate chambers: a high-heat vacuum chamber 602 and a quench chamber 604. Inside the quench chamber is a quench reservoir 606. The vacuum furnace 600 is the furnace in which the metal component is initially heated in the absence of atmosphere. The vacuum within the high-heat chamber 602 is maintained in an environment of less than 500 microns of atmosphere, for example, and the quench chamber 604 is where the metal component is stored temporarily between the heat treatment process and the oil-quenching process. The vacuum furnace's parameters such as the internal temperature and condition therein may also be controlled as needed to achieve the desired microstructure in the metal component (which in this case is bainite) and confirm the same through metallurgical analysis.

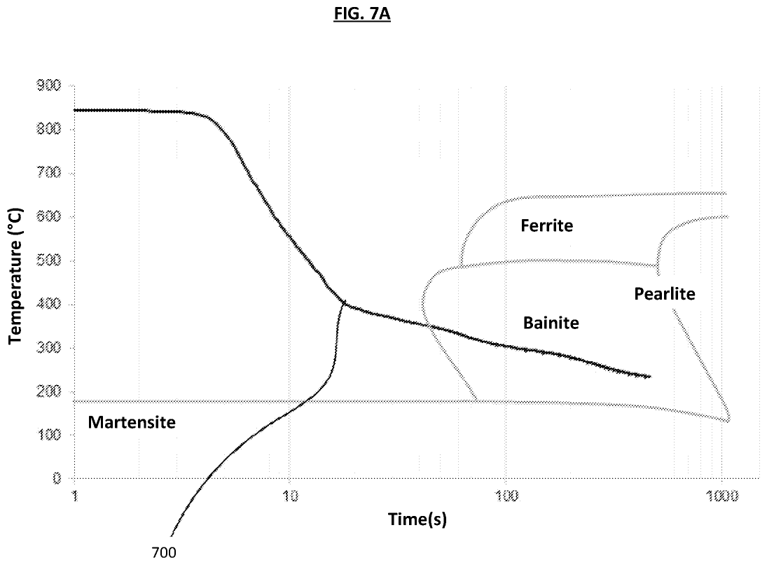

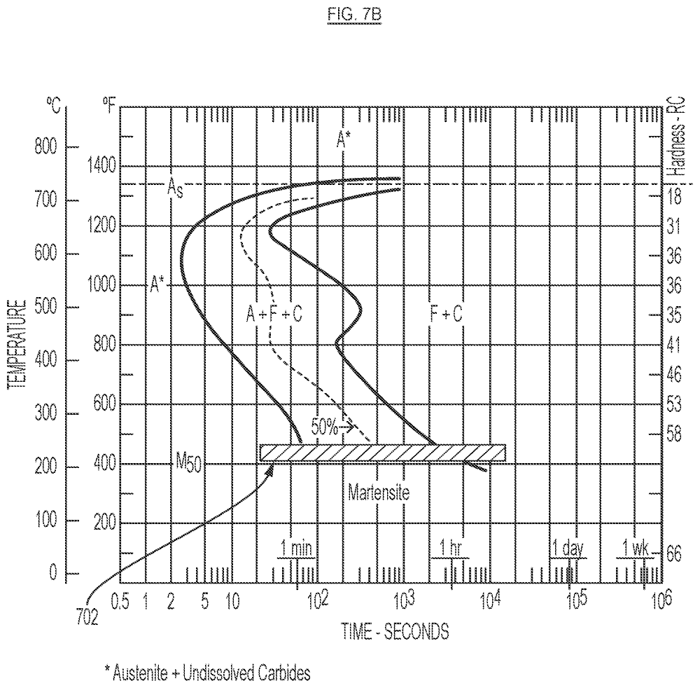

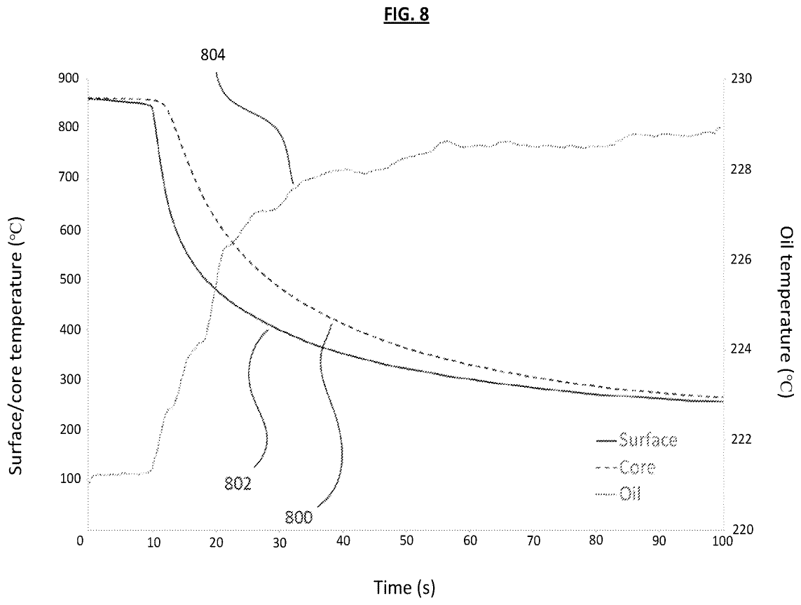

The oil-quenching process is performed in the quench reservoir 606 which stores the oil that is kept at a bainite-forming temperature. The bainite-forming temperature in which the oil is maintained may be at least about 200° C. in some examples. In some examples, the bainite-forming temperature may be at or less than about 230° C. In some examples, a lower threshold of the temperature range may be less than about 200° C. and greater than the temperature range in which martensite is formed. In some examples, an upper threshold of the temperature range may be greater than about 230° C. and less than the temperature range in which ferrite or pearlite is formed. The upper threshold in some examples may be greater than about 250° C., greater than about 270° C., greater than about 300° C., or greater than about 320° C. As shown in FIG. 7A, ferrite may be formed at a temperature of greater than about 470° C. Pearlite may be formed at a temperature of greater than about 723° C., for example. The temperature of the oil may be controlled via a thermocouple and/or heating controller. The types of oil that is used for quenching must thus have a flash point of greater than the temperature that the oil is maintained while inside the quench reservoir. In some examples, the oil has flash point that is greater than about 230° C. In some examples, the flash point of the oil may be greater than about 250° C., greater than 270° C., greater than 300° C., or greater than 320° C., depending on the type of oil being used. Any suitable type of oil with such property may be used, for example vegetable oil, paraffinic base oil, avocado oil, etc.

The metal component, after being heated, is then transferred to the quench chamber and lowered to the quench reservoir 606. In one example, the quench chamber 604 is maintained at an environment of less than 500 microns of atmosphere before, during, and after the transferring of the metal component. In another example, there is an inflow of inert gas in the high-heat vacuum chamber 602 and the quench chamber 604 before, during, and after the transferring of the metal component.

In some embodiments, the quench chamber may have an elevator 608 that moves back and forth between the quench chamber 604 and the quench reservoir 606 such that the heat-treated metal component from the vacuum chamber 602 is transported or transferred from the quench chamber 604 to the high-temperature oil of the quench reservoir 606. After the quenching process is complete, the elevator 608 brings the metal component back to the quench chamber 604 to be taken out and washed.

In some embodiments, the quench chamber 604 has a gas injector 610 which injects the inert gas (including but not limited to argon, for example) to cover a surface of the oil in the quench reservoir 606 so as to facilitate preventing the oil from oxidizing and/or degrading after numerous quench cycles. In some examples, the temperature in which the oil is maintained may range from about 200° C. to about 210° C., about 210° C. to about 220° C., about 220° C. to about 230° C., or any other suitable temperature range therebetween.

In some embodiments, the quench chamber 604 also includes a quench fan 612 which circulates the gas inside the quench chamber 604. In some embodiments, the quench reservoir 606 has a circulator or agitator 614 coupled thereto which circulates or agitates the oil within the reservoir 606 in the directions illustrated by arrows 616 in the drawing. The movement of the oil facilitates to quicken the cooling of the metal component such that the temperature of the metal component can reach the oil temperature faster. The speed at which the temperature of the metal component cools may depend on the speed of the circulator or agitator 614, which is variable to adjust for faster or slower cooling of the metal component.

FIG. 7A illustrates a continuous cooling transformation (CCT) diagram in logarithmic time scale. The diagram represents which types of phase changes will occur in a material as it is cooled at different rates and illustrates the different properties that may be obtained depending on how the metal component is cooled, e.g., ferrite, bainite, pearlite, and martensite as shown. As shown in the CCT diagram, bainite can be obtained if the metal component is maintained between approximately 180° C. and 500° C. for a period of time. If the temperature of the quenching bath is too low (at or below 180° C.), the metal component becomes martensite.

According to the CCT diagram, the curve 700 undergoes two changes in the cooling rate. Specifically, between approximately 1 second and 3 seconds, the temperature remains consistent, after which, between approximately 3 seconds and 11 seconds, the cooling causes a more drastic reduction in temperature, and lastly, after approximately 11 seconds, the cooling rate decreases such that the metal component remains in the bainite-forming area. Specifically, the slower cooling observed after 11 seconds in the oil quenching process causes the metal component to remain inside the bainite-forming area until transformation is complete. This cooling rate from the austenitizing temperature to the oil temperature reduces the amount of mixed microstructure that is formed in the final product (e.g., the mixture of bainite with ferrite).

FIG. 7B illustrates an isothermal transformation (IT) diagram in logarithmic time scale. The diagram shows the phase changes in the material when, the metal component is held in the quench reservoir 606, its temperature is held constant during the transformation to the bainitic phase, and with rapid cooling to the temperature. On the left side of the two solid curves is the region that forms austenite (A), and on the right side of the solid curves is the region that forms ferrite (F) and cementite (C), with the region in between the curves forming a combination of austenite, ferrite, and cementite. Underneath the 200° C. line lies the martensite region.

In order to form bainite, the metal component is to be quenched rapidly after the heat treatment and held in a bainite-forming temperature region, which in some examples may be between about 200° C. and about 230° C. for a period of time between 20 seconds and approximately 4 hours, or 14400 seconds, as shown by a shaded region 702 on the diagram. In some examples, the period of time for which the metal component is to be quenched may be experimentally determined based on the size, shape, length, and/or cross-sectional area of the metal component.

In some examples, thermocouples may be used to confirm the cooling rates on the surface of the metal component and its core. The material is to be held within the region 702 before being further cooled to room temperature for a full bainitic transformation to take place. The length of time defining the region 702 is the time that is taken for completing the transformation of a fully bainitic microstructure; that is, quenching the metal component in this time region reduces the amount of austenite, ferrite, cementite, or martensite microstructure in the final product.

As previous mentioned, molten salt is used in the industry as a known method to quench a metal component, but problems arise from using molten salt. This is because the salt used for quenching is considered a hazardous material to the environment due to its oxidizing nature, and the chemical reaction of the salt creates defects on the surface of the metal component, thereby necessitating the additional step of removing such surface defects using machining, blasting, or peening. Salt particles can also become lodged in the drillings during washing of the metal component. Furthermore, salt can accelerate corrosion of the metal component.

However, using oil at the described temperature range for the quenching bath is also problematic in endothermic atmospheric heat chambers as commonly used in the art, since in the presence of oxygen, oil often oxidizes and forms a sludge during quenching, which consequently lowers the efficiency of the process. Therefore, if oil is to be used for quenching in the endothermic heat chambers, replacing the oil frequently is vital to reduce inefficient quenching, or the oil must be maintained at a lower temperature to reduce the amount of oxidation taking place. However, as explained herein, the lower quenching temperature below the described temperature range facilitates the formation of martensite, which is undesirable when the desired final product is bainite.

In view of the above, the processes as disclosed herein, using the vacuum furnaces to heat the metal component and using the high-temperature oil to quench the metal component, reduces not only the hazard that comes with using molten salt for quenching but also removes the negative effect of the sludge forming in the oil resulting from oxidizing, since there is no oxygen present in the quench reservoir which stores the oil. Washing oil out of drillings is more effective than washing salt that is lodged in the drillings. Oil is also effective for rust prevention on metal components. As such, the curve 700 can undergo a slower cooling in the high-temperature oil maintained in an oxygen-less environment.

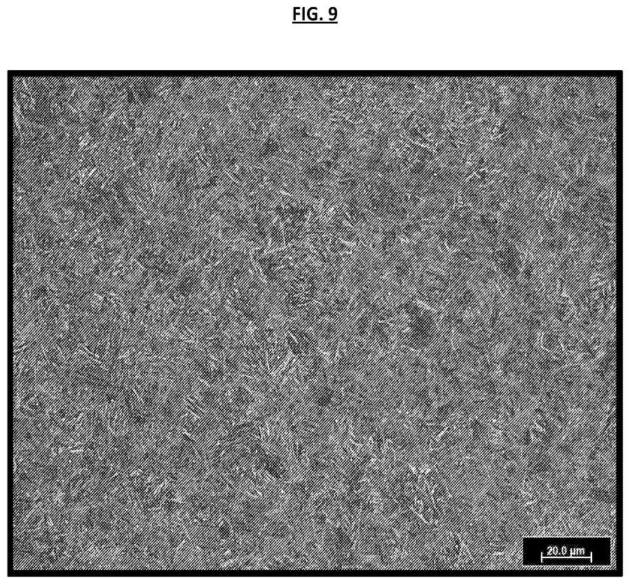

FIG. 8 is a graph showing the temperature changes during quenching in a core 800 of the metal component, on a surface 802 of the metal component, and of an oil 804 in which the metal component is submerged. As observed in the graph, the surface 802 of the metal component cools to reach approximately 220° C. (428° F.), the temperature at which the oil is initially maintained, and the core 800 approaches the temperature. The oil 804 increases in temperature due to the heat released from the metal component.

It is to be noted that in the example shown, the metal component is held in the oil at a temperature of 218° C. (425° F.) for 3.5 hours before being cooled. The resulting bainite component has a hardness of between 50HRC and 60HRC, for example 58HRC (on the “Hardness Rockwell C” scale), with no visible retained austenite. Typically, a hardness of between 50HRC and 60HRC is needed for austempering process. Furthermore, in some examples, the resulting bainite component has no visible defect that are formed on the surface as a result of oxidation. In some examples, such defect includes any defect visible to the naked eye. In some examples, such defect includes any defect visible under 10× magnification, 20× magnification, 50× magnification, 100× magnification, 200× magnification, or any other suitable magnification or range of magnification therebetween. The bainite component is thus useful for its fatigue resistant properties to withstand high pressures. A fully bainitic microstructure of the component is observed under 500× magnification, as shown in FIG. 9, with no retained austenite being observed.

Although the examples and embodiments have been described in detail with reference to certain preferred embodiments, variations and modifications exist within the spirit and scope of the disclosure as described and defined in the following claims.

1. method of obtaining bainite comprising:
heating a metal component in a vacuum chamber of a vacuum furnace to raise an internal temperature of the metal component to an austenitizing temperature;
transferring the metal component from the vacuum chamber to a quench chamber of the vacuum furnace;
quenching the metal component in oil that is maintained at a bainite-forming temperature range within a quench reservoir of the quench chamber; and
removing the metal component from the quench chamber after a predetermined period of time.

2. The method of claim 1, wherein the bainite-forming temperature range has a lower threshold of at least about 200° C.

3. The method of claim 1, wherein the bainite-forming temperature range has an upper threshold at or less than about 230° C.

4. The method of any one of claim 1, wherein the metal component is a steel alloy containing at least 0.4% carbon and the austenitizing temperature of the metal component is between 815° C. and 880° C.

5. The method of claim 1, further comprising introducing carbon into the vacuum chamber during heating of the metal component to produce case-hardened bainite from the metal component, wherein the metal component is a steel alloy containing 0.3% carbon or less.

6. The method of claim 5, wherein the austenitizing temperature of the metal component is between 815° C. and 950° C.

7. The method of any one of claim 1, further comprising maintaining an inflow of inert gas into the quench chamber for a period of time before, during, and after the furnace is opened to remove the metal component from the quench chamber.

8. The method of claim 7, further comprising maintaining the inert gas to entirely cover a surface of the oil within the quench reservoir to reduce oxidation or degradation of the oil.

9. The method of any one of claim 1, further comprising washing the metal component after removing the metal component from the quench chamber.

10. The method of any one of claim 1, wherein the oil has a flash point of greater than 230° C.

11. A vacuum furnace for producing bainite by austempering, the vacuum furnace comprising:
a vacuum chamber configured to heat a metal component to raise an internal temperature of the metal component to an austenitizing temperature; and
a quench chamber including a quench reservoir configured to store oil that is maintained at a bainite-forming temperature range to be used to quench the metal component after the metal component is transferred from the vacuum chamber to the quench chamber until bainitic transformation of the metal component is complete.

12. The vacuum furnace of claim 11, wherein the quench chamber further comprises an elevator configured to transport the metal component from the quench chamber to the quench reservoir.

13. The vacuum furnace of claim 11, wherein the quench chamber further comprises a gas injector configured to maintaining an inflow of inert gas into the quench chamber for a period of time before, during, and after the furnace is opened to remove the metal component from the quench chamber.

14. The vacuum furnace of claim 13, wherein the quench chamber or the gas injector is configured to maintain the inert gas to entirely cover a surface of the oil within the quench reservoir to reduce oxidation or degradation of the oil.

15. A bainite component formed by the method of any one of claim 1, wherein the bainite component has a hardness of between 50HRC and 60HRC with no retained austenite, and a surface of the bainite component has no defect formed as a result of oxidation that is visible to a naked eye.

16. The bainite component of claim 15, wherein the surface of the bainite component has no defect formed as the result of oxidation that is visible under 10× magnification.
